(19) United States
(12) Patent Application Publication
(10) Pub. No.: US 2006/0130119 A1
(43) Pub. Date: Jun. 15, 2006

(54) Advanced parental control for digital content

(76) Inventors: Brant L. Candelore, San Diego, CA (US); Leo M. Pedlow JR., San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/227,584

(22) Filed: Sep. 15, 2005

Related U.S. Application Data
(60) Provisional application No. 60/636,504, filed on Dec. 15, 2004.
(60) Provisional application No. 60/637,305, filed on Dec. 16, 2004.

(51) Int. Cl. H04N 7/16; H04N 7/025; H04N 7/173; H04N 7/10

(52) U.S. Cl. 725/135; 725/32; 725/118; 725/148

(57) ABSTRACT

According to one embodiment, a method for replacing scenes of objectionable content comprises receiving incoming content, which includes main content and replacement content. The main content is the content originally intended as a scene of a program while the replacement content is content for replacing the main content for the scene of the program. Thereafter, a determination is made if the scene of the program includes objectionable content, and if so, substituting the main content with the replacement content provided the replacement content does not include the objectionable content.

### CROSS-REFERENCE TO RELATED APPLICATIONS

This application claims the benefit of priority on U.S. Provisional Patent Application No. 60/636,504 filed Dec. 15, 2004 and U.S. Provisional Patent Application No. 60/637,305 filed Dec. 16, 2004, the contents of which are incorporated by reference.

### BACKGROUND

1. Field

Embodiments of the invention relate to parental control of digital content. More specifically, one embodiment of the invention relates to an apparatus and method for modification or elimination of unwanted video or audio on a scene-by-scene basis.

2. General Background

Television is used to deliver content, such as entertainment and educational programs, to viewers. A growing number of parents are now watching and listening to content perceived by their children, in an effort to better mitigate their exposure to objectionable content, namely violence, sexual situations, indecent or suggestive language and the like.

Currently, with respect to the rendering of video programs, televisions are implemented with a V-chip, which may be set by parents to preclude the playback of programs that exceed a selected age-based rating. A black screen is shown for any program that exceeds the selected age-based rating in order to prevent such viewing. This program blocking can be disabled with a parental password.

There are a number of major shortcomings of the V-chip. For instance, the V-chip filters only at the program level, namely a viewer gets to view the entire program or nothing at all. In other words, there are no intermediate levels of blocking, which prevents the playback of certain programs that would be appropriate and perhaps educational for children if certain images or audio were eliminated. Also, how programs are rated is still a subjective task, and the assigned ratings may not be consistent with the views of certain parents. As an example, some programs with violence or drug use may receive a lower rating than programs with indecent language, but certain parents might consider violence to be more objectionable. Yet another V-chip shortcoming is that it is unable to filter commercials or other advertisements, news clips or live sporting events since this content is not rated.

The marketplace already features filters, but none of which provide any capability of scene-to-scene filtering and content replacement. For instance, a CLEARPLAY® DVD player from RCA has the ability to use downloadable filters synchronized to the playback of the DVD to squelch violence, nudity, swearing and other content that some may find objectionable. However, this product is directed to DVD video data streams, not broadcast programming and fails to provide any mechanism for content replacement.

Another filter is a language filter from TVGuardian, which operates only on audio. This filter relies on closed captioning information to automatically detect and filter audio which some might find objectionable. Hence, there is a strong reliance on the accuracy of closed captioning information. When objectionable audio is detected, sound is muted and alternate closed captioning text is displayed on the screen. No audio or video replacement is offered. Unfortunately, the muting of sound may be for a longer period of time than needed, namely well before and after the appearance of the word in the closed captioning. This may adversely affect the understanding of the program by the viewer.

### BRIEF DESCRIPTION OF THE DRAWINGS

Embodiments of the invention are illustrated by way of example and not by way of limitation in the figures of the accompanying drawings, in which like references indicate similar elements and in which:

FIG. 1 is an exemplary operational flow of primary and replacement content to provide multiple sub-versions of content for coordination by the content filter unit based on parental control parameters.

FIG. 2 is an exemplary block diagram of a content delivery system consistent with certain embodiments of the invention.

FIG. 3 is an exemplary block diagram of a content provider consistent with certain embodiments of the invention.

FIG. 4 is an exemplary diagram of a content filter unit implemented within a digital device of the content delivery system of FIG. 2.

FIGS. 5A and 5B are exemplary diagrams of an Adaptation field of an I-frame, being a portion of a MPEG packet of the digital data stream.

FIG. 6 is an exemplary diagram of a first embodiment of a content replacement process consistent with certain embodiments of the invention.

FIG. 7 is an exemplary diagram of a second embodiment of a content replacement process consistent with certain embodiments of the invention.

FIG. 8 is an exemplary state diagram of content segment replacement (e.g., packet swapping) based on multiple, alternate PIDs in order to remove objectionable content or to add objectionable content.

FIG. 9 is an illustrative example of a packet swapping operation for an incoming broadcast data stream in accordance with the state diagram of FIG. 8.

FIG. 10 is an illustrative flowchart of a process for determining whether a segment of content associated with a program should be prevented from being displayed.

FIG. 11 is an illustrative flowchart of a process for substituting replacement segments of content based on parental control parameters.

FIG. 12 is an exemplary embodiment of a Age-based Rating scheme for modification or substitution of scenes including objectionable content.

FIG. 13 is an exemplary embodiment of a Content-based Rating scheme for modification or substitution of scenes including objectionable content.

FIGS. 14A and 14B are exemplary embodiments of a Tag Rating scheme for modification or substitution of scenes including objectionable content.

FIG. 15 is an exemplary embodiment of the illustrative flow of information and operations for an override scheme to override scene replacement based on tag evaluations.

FIGS. 16A-16G are exemplary diagrams of graphic user interface (GUI) that enables users to program the content filter unit.

FIG. 17 is an exemplary diagram of a post-recording content replacement process consistent with certain embodiments of the invention.

### DETAILED DESCRIPTION

Various embodiments of the invention relate to an apparatus, system and method for parental control of digital content. According to one embodiment of the invention, a content filter unit is implemented within a digital device and is configured to provide parental control by performing scene-by-scene evaluation of incoming content (e.g., a stream of video, images, audio or any combination thereof) and subsequent modification or elimination of objectionable content.

In short, the content filter unit provides scene-by-scene filtration, and even to the granularity of frame-by-frame, to block or replace individual scenes or words. Such blocking may be accomplished by the content filter unit residing with the customer through screen blocking or obscuring pixels for a particular image or muting audio. Alternatively, content within the scene can be replaced in order to reduce the rating of the program (referred to as “down-rating”), or may even be replaced to reinsert content that was previously obscured/removed in order for the programming to achieve the higher rating (referred to as “up-rating”). The replacement content may be sent in the same digital stream as the main content, and is synchronized with the content that it is replacing for swapping on-the-fly. Thus, the rendering of higher or lower rated content is accomplished, where programs can be created and broadcast with multiple versions having different content and ratings. Also, all content, including advertisements, news, sporting events and the like may be filtered as well in lieu of just movies and television shows.

For purposes of the present description, the term “digital device” may refer to a television that is adapted to tune, receive, decrypt, descramble and/or decode transmissions from any content provider. Examples of “content providers” may include a terrestrial broadcaster, a cable or satellite television distribution system, or a company providing content for download over the Internet or other Internet Protocol (IP) based networks like an Internet service provider. However, it is contemplated that the digital device may be of another form factor besides a television, such as a set-top box, a personal digital assistant (PDA), a computer, a cellular telephone, a video game console, a portable music player, a stereo system, a personal video recorder, or the like.

In the following description, certain terminology is used to describe features of the invention. For example, in certain situations, the terms “component,” “unit” and “logic” are representative of hardware and/or software configured to perform one or more functions. For instance, examples of “hardware” include, but are not limited or restricted to an integrated circuit such as a processor (e.g., a digital signal processor, microprocessor, application specific integrated circuit, a micro-controller, etc.). Of course, the hardware may be alternatively implemented as a finite state machine or even combinatorial logic.

An example of “software” includes executable code in the form of an application, an applet, a routine or even a series of instructions. The software may be stored in any type of machine readable medium such as a programmable electronic circuit, a semiconductor memory device such as volatile memory (e.g., random access memory, etc.) and/or non-volatile memory (e.g., any type of read-only memory “ROM”, flash memory, etc.), a floppy diskette, an optical disk (e.g., compact disk or digital video disc “DVD”), a hard drive disk, a tape, or the like.

In addition, the term “program” generally represents a stream of digital content that is configured for transmission to one or more digital devices for viewing and/or listening. According to one embodiment, the program may contain multiple Packet Identifiers (PIDs) when the program is MPEG (Moving Pictures Expert Group) compliant compressed video. These multiple PIDs provide for replacement of one scene of content for another. The “scene” is defined as one or more frames of content, namely video, images, audio or any combination thereof. For instance, a scene may be one or more frames of video and/or audio, or even a packet of music downloaded into a portable music player.

More specifically, multiple PIDs may be associated with a single program in order to provide content replacement for this program. Content replacement provides an enhanced level of viewing/listening customization. For example, content replacement can be used to provide targeted advertising to an audience by the substitution of one advertisement determined to be “objectionable” for another. Content replacement can also be used to provide multiple scenes, endings or other segments for a program, or perhaps to provide multiple views in a sportscast or other program. Other applications for the content replacement of the invention fall within the spirit and scope of the invention.

Certain types of content, such as movies, have an associated content rating established by a supervisory body to inform potential viewers of the type of material that may form a part of the content. General ratings of G, PG, PG-13, R and NC-17 are commonly established for most movies produced in the United States by the Classification and Ratings Administration (CARA) of the Motion Picture Association (MPA) or the Motion Picture Association of America (MPAA). Television programming is similarly rated by the TV Parental Guidelines Monitoring Board, which provides ratings of TV-Y, TV-Y7, TV-Y7-FV, TV-G, TV-14 and TV-MA.

For purposes of this document, content having a rating provided under such rating systems will be referred to as having a “higher” rating if it is intended for more mature audiences, and a “lower” rating if it is intended for a more general or less mature audience. Hence, the previously described rating systems are listed from lowest to highest. Therefore, within this terminology, an R rating would be considered a “higher” rating than a G rating. Such nomenclature is defined herein for simplicity of description of the above rating system as well as equivalent systems, without intent for the nomenclature to pass any judgment on the quality of such content.

Additionally, the term “rating” is intended to embrace any suitable content rating system, domestic or foreign, public, private or even governmental that is formed to serve a similar function. Such rating information may be provided as data embedded within program specific information such as data inserted into an Adaptation field of a MPEG packet for example when the content is video.

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described.

I. General Overview of Inventive Aspects

The content filter unit described below provides studios and directors with an ability to preserve their artistic freedom and preempt any legislative mandates regarding parental control. The content filter unit allows programs to be created and broadcast with multiple “subversions” and parental ratings at the same time.

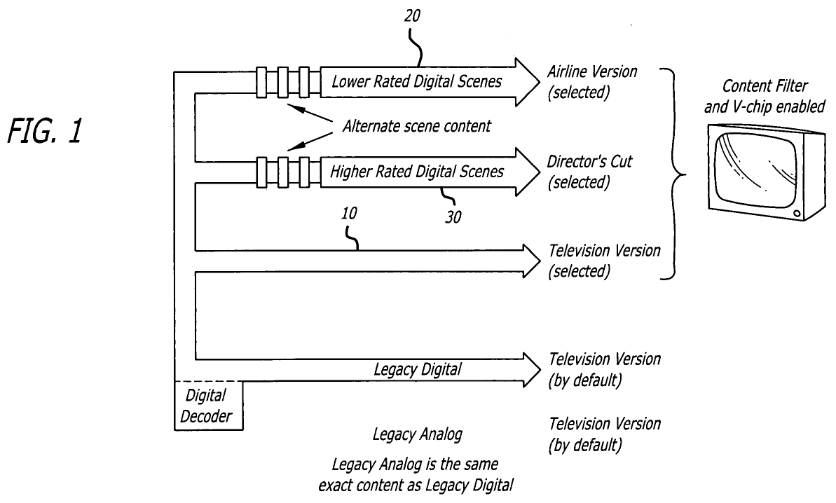

For example, as shown in FIG. 1, working with the existing practices of providing the director's cut, television and airline versions of movies and shows, the operations of a content filter unit (described below) would allow studios and directors to start with the television version as the “default” main content 10 (e.g., rated TV-PG), and simultaneously render lower rated content 20 for airline playback (rated TV-G) and higher rated content 30 being director's cut (rated TV-14) version. Hence, legacy digital devices may still rely on V-chip technology for parental control.

The studios can cater to opposite extremes—those who believe the public should be able to watch everything, and those who believe that segments of the public, such as families with children, should be protected from watching what some might consider objectionable content. These divergent interests can be accommodated at the same time.

This content filtering can be applied not only to movies and television shows, but also to advertisements, sporting and news events and other content that could not be practically controlled. For example, advertisers will be able to create multi-rated commercials with higher/lower rated segments at the same time. Also, objectionable scenes in sporting or new events can be broadcast blocked at one digital device and uncensored at another.

As an example, during the SUPERBOWL® sporting event in 2005, a CIALIS® commercial was shown. Thousands of families, with young sports enthusiasts at home, watched this advertisement since advertisements are treated as separate content to television shows and are not rated.

The below-described content filter unit, however, is adapted to selectively control the playback of commercials. For example, if FDA medical disclosure rules legally require the disclosure of side effects for “male enhancement” products, the audio may be required to be played back and not muted. Instead, the entire commercial could be substituted for what some might consider a less objectionable second commercial that is transmitted in accordance with prescribed time constraints to allow the replacement advertisement to be seamlessly substituted. Another possibility is the display of a static banner ad for the advertised product without audio. This would allow advertisers to control the particular time slot for a commercial without interference. If the wording is not legally required, it could be muted.

Live sporting events represent a special problem for parental control. Someone must watch the feed, recognize that something in the telecast would violate the sensibilities of the viewing public at large, and be ready to “pull the plug”. This is especially difficult since the objectionable event might be something outside the principle focus, such as patrons in the stands.

The content filter unit could allow both a blocked, primary default feed version and uncensored version to be distributed at the same time. Adults watching the sporting event might not mind the “shock value” of a wardrobe malfunction” or other racy content, while others with young children will view the blocked content.

News commentators or reporters are generally good about warning the public that upcoming scenes in a clip may be objectionable to some in the viewing public. Nonetheless, it may be difficult for the viewing public to act quickly and change the channel or mute the sound. Also, live reporting from in-field reporters sometimes show objectionable content such as on-going gunfire. Similar to the live sporting events, in the case of what some might consider inappropriate news content, the program may be simultaneously broadcast with both blocked and uncensored versions of content.

II. General Architecture

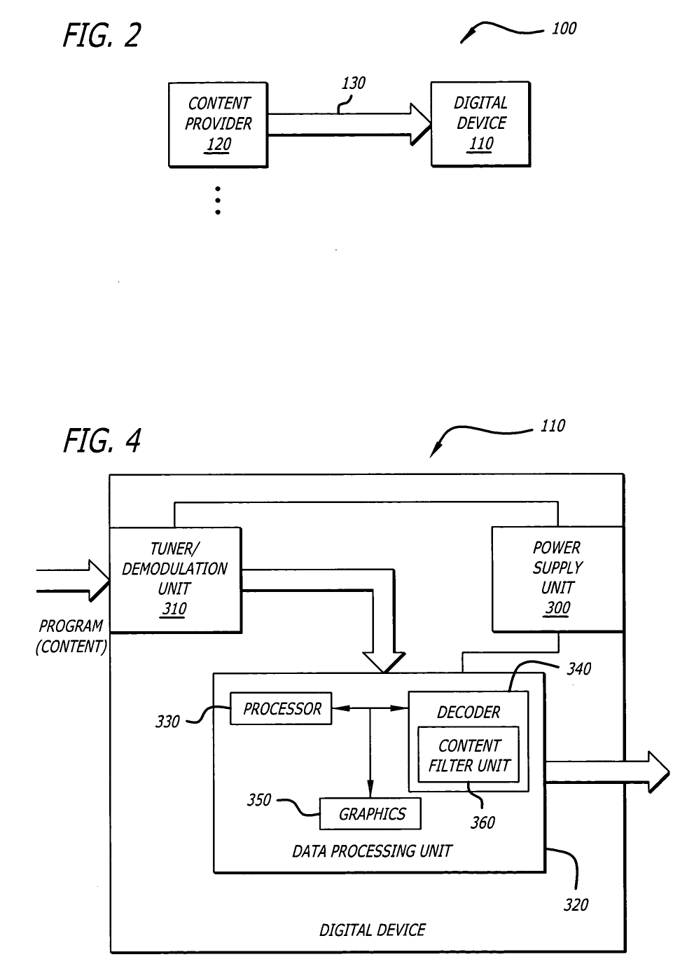

Referring to FIG. 2, an exemplary block diagram of a content delivery system 100 consistent with certain embodiments of the invention is shown. Content delivery system 100 comprises a digital device 110 that receives digital content such as a program from one or more content providers 120. The program may be propagated as a digital data stream for example in compliance with any data compression scheme. Examples of a data compression scheme include, but are not limited or restricted MPEG standards.

According to one embodiment of the invention, digital device 110 decodes an incoming program, and evaluates the content of the incoming program on a scene-by-scene basis to determine whether such scenes include any objectionable content. Such evaluation may involve a review of the rating assigned to each scene or perhaps access data within tags assigned to each scene to determine whether the scene includes any objectionable content. These evaluation schemes are described below.

Since digital device 110 may be adapted to increase or decrease the rating of the program, the term “objectionable content” has two meanings. One meaning is that it is content featuring certain subject matter that may be inappropriate for the viewing or listening audience at this time. Another meaning is that it is low-rated content that can be substituted for higher rated content due to the mature nature of the viewing or listening audience and their request for up-rating of content.

Content provider 120 provides the digital content to digital device 110 through transmission medium 130, which operates as a communication pathway for the program within content delivery system 100. The transmission medium 130 may include, but is not limited to electrical wires, optical fiber, cable, a wireless link established by wireless signaling circuitry, or the like.

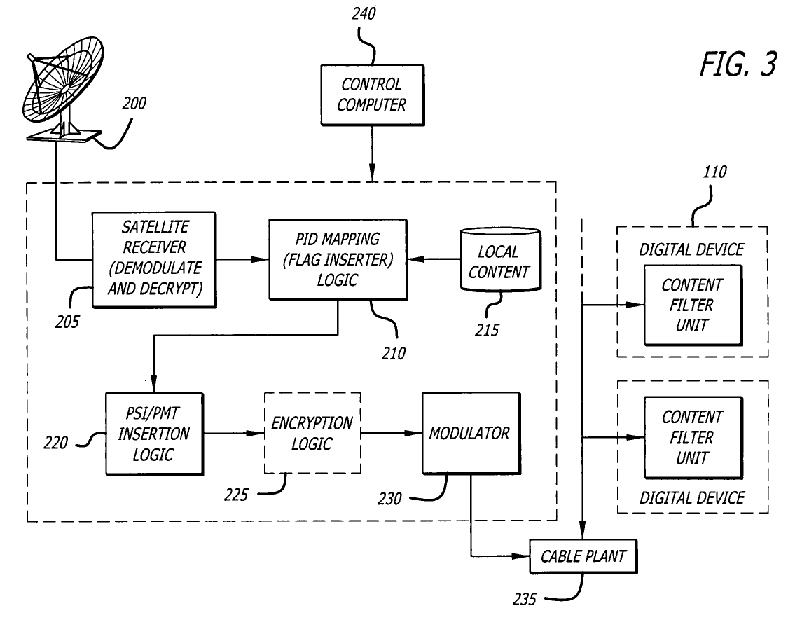

Content provider 120 may be adapted with a satellite antenna 200 to receive a multiplexed stream of content from a satellite transmission as shown in FIG. 3. The stream of content is received, demodulated and decrypted at a satellite receiver 205 before being routed to PID Mapping logic 210. The stream of content may include replacement content associated with secondary PIDs. Alternatively, the replacement content may be retrieved from a local content database 215 or other sources of content.

PID mapping logic 210 maps the incoming content from whatever source to a set of primary PIDs and a set of secondary PIDs. The incoming content includes (i) content originally intended for rendering (referred to as the “main content”) and (ii) substitution content for various scenes (referred to as “replacement content”). The main content is associated with the primary PIDs and the replacement content is associated with the secondary PIDs. According to this embodiment, PID mapping logic 210 may also be adapted to insert flags (or markers) into the content in order to identify the location where replacement content is to be inserted.

The mapped content then is routed to PSI/PMT insertion logic 220 that inserts Program Specific Information (PSI) and Program Map Tables (PMT) into the content for use by the decoding side in decoding the programming. If the content is to be encrypted, it may optionally pass through encryption logic 225 prior to modulation at a modulator (e.g., a QAM modulator) 230. The modulated stream of content is then transmitted via transmission medium 130 to digital device 110 and perhaps other digital devices. For instance, the modulated stream of content may be routed to via a cable plant 235 to digital device 110 residing with the end users. The operation performed by content provider 120, including but not limited to the PID mapping for content replacement, is carried out under control of a control computer 240.

In general, a system can be used to form a content substitution encoder consistent with certain embodiments of the invention in which input data inclusive of main content and replacement content. PID mapping logic 210 assigns a primary PID to the main content and assigns a secondary PID to the replacement content. Private data to identify the main content by the primary PID and replacement content by the secondary PID, along with the main content mapped to the primary PID and the replacement content mapped to the secondary PID, are assembled into a data stream.

Of course, it is contemplated that PID mapping logic 210 may be instructed to remap the PIDs to select only the desired content based on parental control parameters routed to content provider 120 from various digital devices. Hence, if utilized, secondary PIDs may be associated with previously substituted segments of main content.

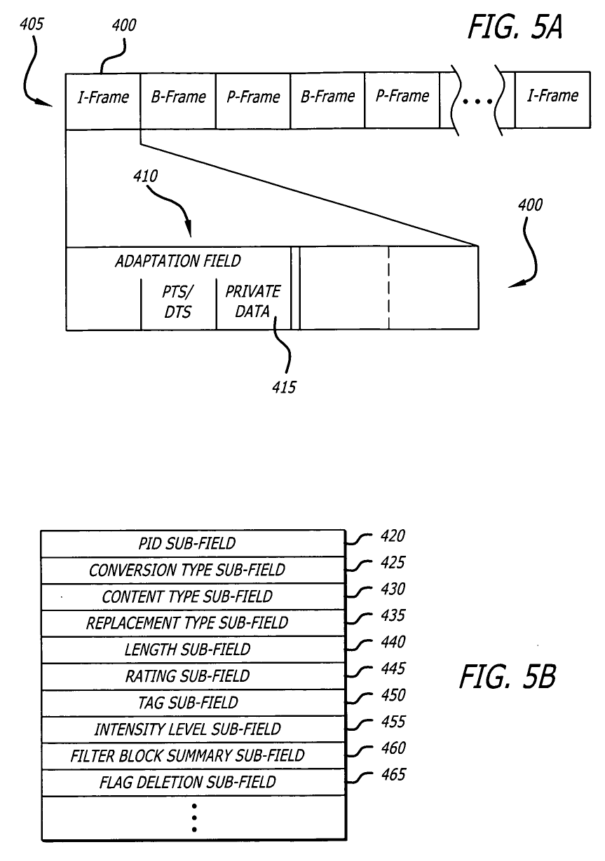

Referring now to FIG. 4, an exemplary diagram of digital device 110 of the content delivery system 100 is shown. Digital device 110 comprises a power supply unit 300, a tuner/demodulation unit 310 and data processing unit 320. Power supply unit 300 is adapted to provide powered to tuner/demodulation unit 310 and data processing unit 320. Power supply unit 300 may provide regulated power based on input power received from a wall socket (e.g., 110 volts alternating current “VAC”, 220 VAC, etc.). Tuner/demodulation unit 310 tunes to a channel to receive the program and demodulates an incoming program to recover the content. Then, the content is routed as a digital bit stream to data processing unit 320.

Data processing unit 320 comprises a processor 330 (e.g., central processing unit), a decoder 340 and a graphics component 350. These components may be implemented as separate integrated circuits or as a single integrated circuit (system-on-chip implementation) as shown.

According to one embodiment of the invention, decoder 340 is implemented with a content filter unit 360 that is adapted to alternatively select replacement content during playback of video and/or audio. In general, according to one embodiment of the invention, content filter unit 360 is designed to select alternate PID(s) from the digital bit stream based on findings by processor 330, which accesses meta data in Adaptation fields within MPEG packets to obtain information for use in evaluating whether a scene has objectionable content.

According to one embodiment, processor 330 is adapted to process the closed captioning and emergency alert system (EAS) data as well as guide data. In addition, processor 330 may be adapted to access the meta data in Adaptation fields of MPEG packets in order to provide signaling to content filter unit 360 regarding the subject matter within each scene that is scheduled to be played back in the near future. This allows content filter unit 360 to determine whether the subject matter constitutes objectionable content.

Of course, it is contemplated that decoder 340 may be adapted to access the meta data itself. Moreover, as an alternative embodiment, decoder 340 may be adapted to separate certain types of data, such as closed captioning or EAS data for processing by processor 330.

Graphics component 350 is adapted for rendering on-screen menus or guide data. For instance, processor 330 may be adapted to collect guide data and for storage of such guide data in local memory (not shown). When such data is requested, it is displayed by graphics component 350, which would overlay video concurrently displayed. Also, graphics component 350 may be adapted to distort or blank out displayed images.

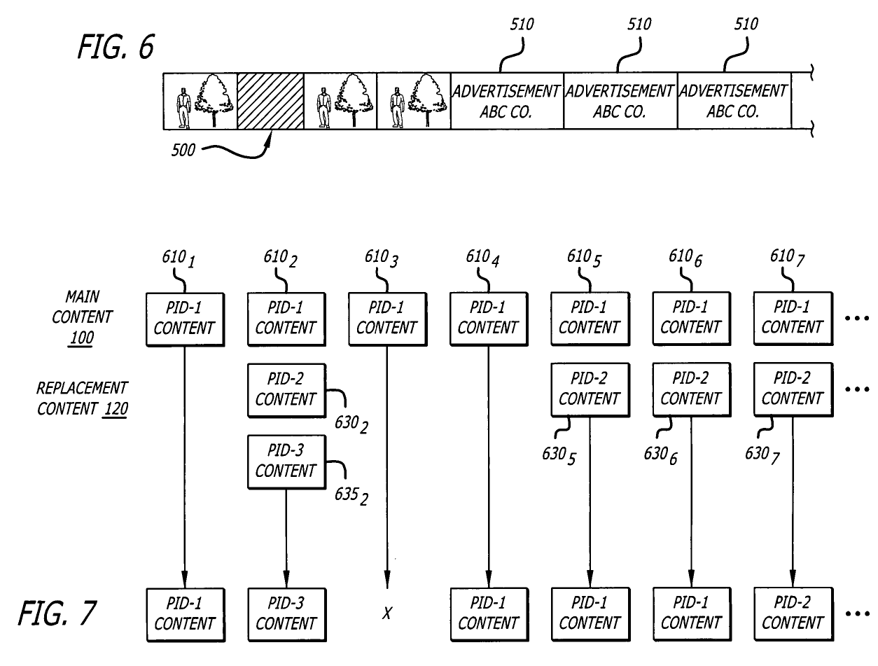

Referring to FIGS. 5A and 5B, exemplary diagrams of an Adaptation field 410 of an I-frame 400, being a portion of a MPEG packet 405 of the digital data stream is shown. Adaptation field 410 features control information 415 (also referred to as “private data”) to initiate a filtering operation is shown. According to one embodiment of the invention, the Adaptation field 410 includes control information 415 used by processor 330 or decoder 340 of FIG. 4 to (i) determine if content replacement is enabled or disabled and (ii) evaluate whether replacement content should be used. Such evaluation is conducted ahead of any scheduled rendering (playback for visual or audible perception) of scenes of digital content.

The Adaptation field 410 includes control information 415 that features a plurality of sub-fields, including but not limited or restricted to one or more of the following:

(1) PID sub-field 420, (2) Conversion type sub-field 425; (3) Content type sub-field 430; (4) Replacement type sub-field 435; (5) Length sub-field 440; (6) Rating sub-field 445; (7) Tag sub-field 450; (8) Intensity level sub-field 455; (9) Filter blocking summary sub-field 460 and (10) Flag deletion sub-field 465.

As illustrated in FIG. 5B, the PID sub-field 420 is adapted to identify what PIDs are provided for a scene started by I-frame 400. These PIDs may include a single (Primary) PID where no replacement content is available, and/or one or more secondary PIDs (e.g., PID-2, PID-3, etc.).

Conversion sub-field 425 identifies whether the replacement content associated with a secondary PID is an up-rating (e.g., increasing the rating level and making the program for more mature audiences) or a down-rating (e.g., decreasing the rating level and making the displayed program for more general audiences).

Content type sub-field 430 identifies the type of content associated with I-frame 400 and the scene associated with I-frame 400. For instance, content type sub-field 430 may identify the content as a movie, a television series, a news clip, a live sporting event, a live entertainment event such as a concert, etc. This information is used to allow content filter unit 360 of FIG. 4 to filter a variety of types of content, especially those types of content that have not been subject to a ratings scheme.

Replacement type sub-field 435 identifies the type of replacement scheme available. For instance, the replacement scheme may involve full scene replacement or inter-scene data replacement (e.g., pixel obfuscation, audio muting, etc.) to reduce transmission bandwidth requirements. Alternatively, the replacement scheme may simply involve the insertion of content markers that are used by PVRs or other types of digital devices to adjust content playback during post-recording solutions.

Length sub-field 440 identifies the number of frames (I, B, P) associated with the length of the digital data stream forming the content.

Rating sub-field 445 provides an age or content rating associated with the scene that are used to determine if any modification, replacement or preclusion involving the rendering of a scene is required.

Tag sub-field 450 provided expanded filtering capabilities that enable filtering to be conducted based on specific types of content found in each scene and not the overall rating of the scene.

Intensity level sub-field 455 provides an alphanumeric value of the intensity of certain subject matter, such as levels of violence, sex or language for example, to provide greater granularity for the filtering operation. This granularity may avoid false-positives where some content may feature content that is in an objectionable category, but such inclusion is minimal or not graphic.

Filter blocking summary sub-field 460 provides for a contextual (tag) overrides described below.

Flag deletion sub-field 465 is a flag (or marker) used by PVR and perhaps other recording digital devices to remove blocking content.

III. Content Replacement Techniques

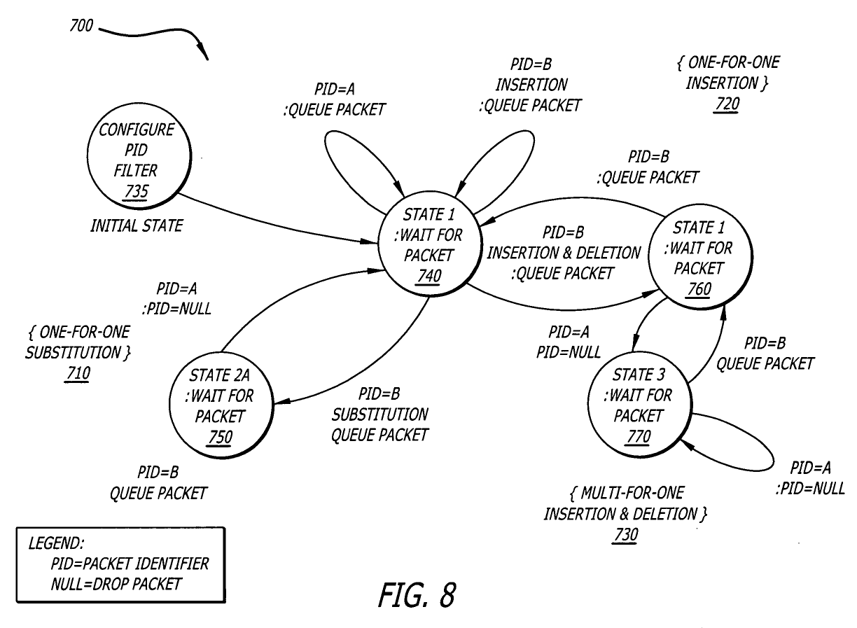

Referring to FIG. 6, an exemplary diagram of a first embodiment of a content replacement process consistent with certain embodiments of the invention is shown. For this embodiment, no replacement content is provided in the digital data stream, but control information is placed within the MPEG packets such as within the Adaptation field of the I-frame as described above. In response to detecting objectionable content, accomplished by comparing preset parental control parameters with information contained in rating, tag and/or intensity sub-fields 445-455 of FIG. 5B, the content filter unit causes a black frame 500 to be displayed in lieu of the objectionable content. Alternatively, a pre-stored banner 510, namely selected advertisements paid by various companies having a rating no greater than limits (e.g., ratings, the presence or of certain subject matter or maturity levels matter, etc.) established for the parental control parameter(s) (hereinafter referred to as “parental control limits”), may be displayed if the blocking is for a longer duration such as successive scenes for example.

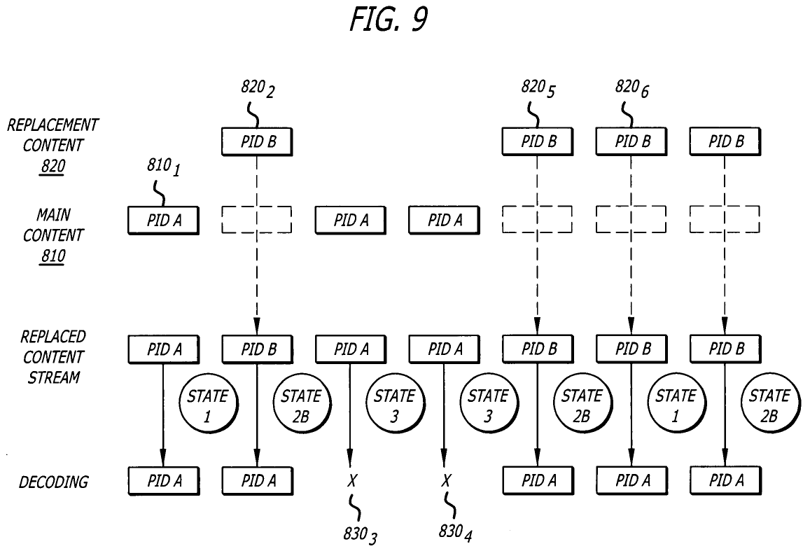

Referring now to FIG. 7, an exemplary diagram of a second embodiment of a content replacement process consistent with certain embodiments of the invention is shown. For this embodiment, main content 600 formed by a plurality of content segments 610₁-610_{N} (where N≧1), which are associated with corresponding primary PIDs (PID-1) and loaded into content filter unit 360 of FIG. 4. Replacement content 620, namely replacement content segments 630₂, 630₅-630₇ & 635₂ associated with certain secondary PIDs (PID-2, PID-3), is also provided to the content filter unit. Replacement content segments 630₂, 630₅-630₇ & 635₂ may be lower rated or higher rated content than corresponding main content segments 610₂ & 610₅-610₇.

In response to detecting objectionable content in main content segments 610₂ and 610₇, replacement content segments 635₂ and 630₇ are substituted for content segment 610₂ and 610₇, respectively. The collection of main content segments and replacement content segments are output for viewing and/or listening by the end user. Upon evaluation of the main content segment 610₃, it is determined that this also includes objectionable content, but no replacement content segment is provided. As a result, screen blanking or audio muting is conducted as described in FIG. 7 as denoted by “X”.

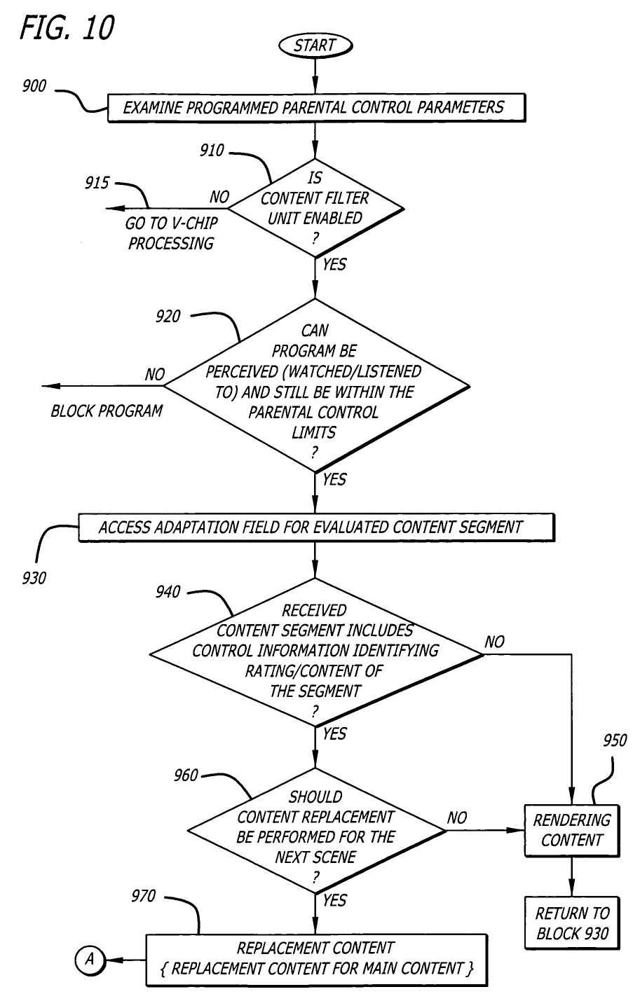

Referring to FIG. 8, an exemplary state diagram of content segment replacement (e.g., packet swapping) based on multiple, alternate PIDs in order to remove objectionable content or to add objectionable content is shown. This involves decoding of a transport stream of content with multiple PIDs as illustrated in FIG. 7 for example.

The replacement of portions of main (primary PID) content, in other words the swapping of a content segment (e.g., packet) of main content with replacement (secondary PID) content is called “Substition Mode” 710. Secondary PID content segments may be inserted into the stream without replacement of the main content. This mode is called “Insertion Mode” 720. In fact, the content filter unit 360 of FIG. 4 may be used in a mode where both operations are active at the same time. This is called “Insertion and Deletion Mode” 730. All three modes of operation 710, 720 and 730 are mutually exclusive and follow a series of state transitions that are specific to each mode.

The decoding of the transport stream of content is conducted by content filter unit 360 of FIG. 4 in accordance with the operations of the state machine 700. The state machine 700 is configured with four operating states, with content filter unit 360 predominantly remaining in State 1 740 after configuration 735. State 2A 750 and State 2B 760 are entered only when a content segment containing a secondary PID (not the primary PID) has been encountered. Depending upon the mode of operation of the content filter unit, as established through messaging in the PSI header from the content provider, different paths to two entirely different second states can be taken.

For instance, a transition from State 1 740 to State 2B 760 can occur due to receipt of a packet marked as “PID B”, where the packet marked as “PID B” is inserted into the Transport stream of content as PID A packets. Any packet received while in State 2B with the PID value matching PID A will result in a transition to State 3 770 and their PID value being changed to NULL, effectively removing it from the transport stream. All subsequent content segments received matching PID A while in State 3 will result in their PID value also being changed to NULL.

The state machine 700 can be implemented in either hardware or software, depending upon the IC manufacturer's device architecture. A software implementation on a programmed processor can generally be expected to provide more flexibility in the design.

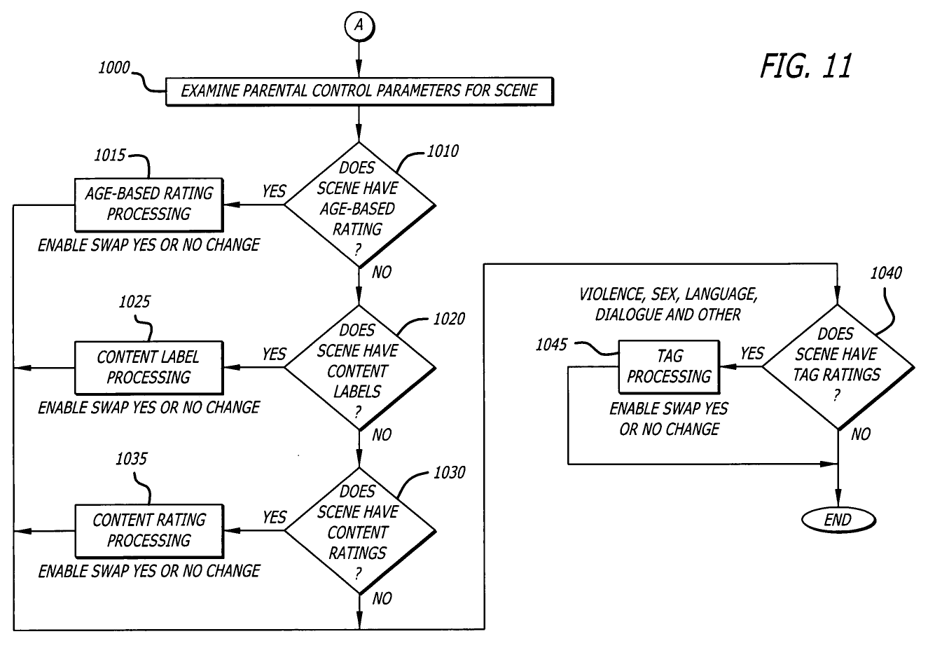

Referring to FIG. 9, an illustrative example of a packet swapping operation for an incoming broadcast data stream in accordance with the state diagram of FIG. 8 is shown. As illustrated, for a first content segment 8101, no objectionable content has been detected. Therefore, the content filter unit 360 of FIG. 4 processes the content segment associated with PID A.

Next, a transition from State 1 740 to State 2B 760 of FIG. 8 occurs after receipt of an insertion flag (not shown), and insertion of PID B into the (content) stream as PID A. Thus, content segment 820₂ is processed for display. Any content segment received during this operation state with PID A value and having objectionable content without any replacement content will result in a transition to State 3 and their PID value being changed to NULL as shown for decoded content segments 830₃ and 830₄, effectively removing them from the content stream.

A transition from State 3 770 to State 2B 760 occurs upon detection of objectionable content and replacement content 820₅ being provided and associated with PID B value. PID B is converted to represent PID A within the Transport stream. Likewise, return to State 1 740 from State 2B 760 occurs when content segment 820₆ with PID B value is received accordingly, it is also queued and converted to the PID A value.

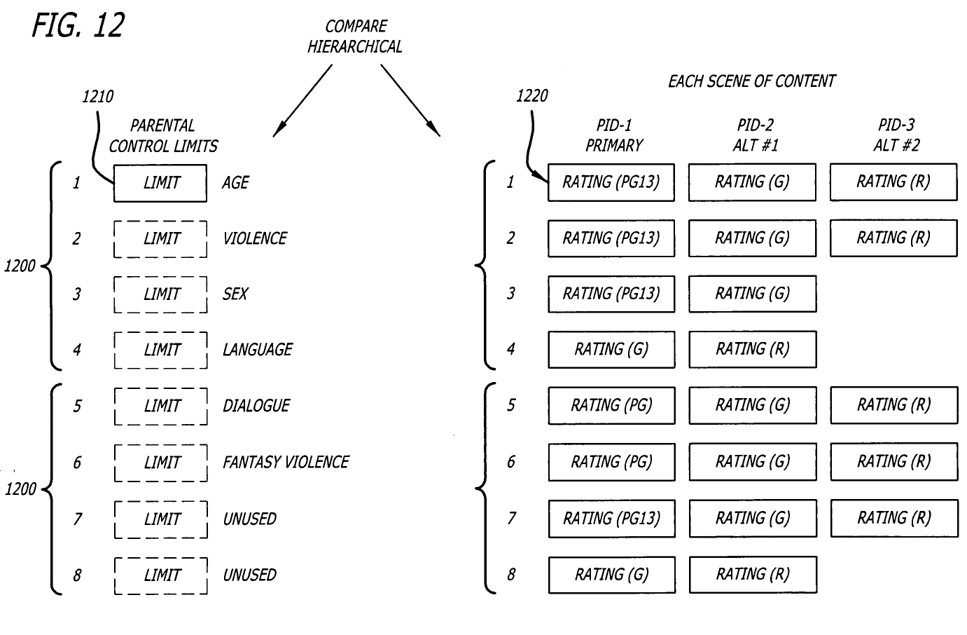

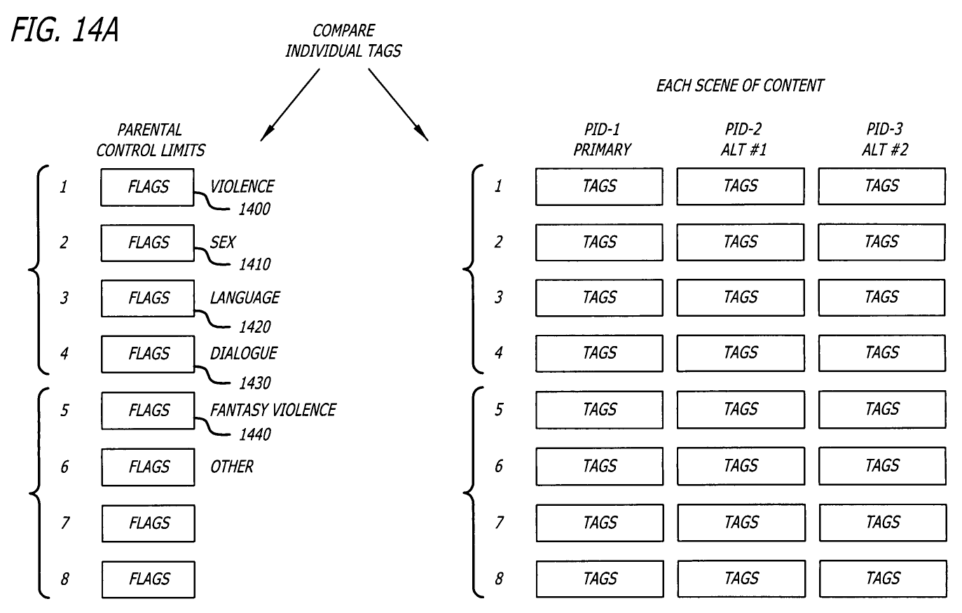

Referring now to FIG. 10, an illustrative flowchart of a process for determining whether a segment of content associated with a program should be prevented from being displayed is shown. As illustrated, initially programmed parental control parameters are examined to determine what constitutes “objectionable content” for this content filter unit (block 900). The parental control parameters are preset as shown in FIGS. 12, 13 and 14A.

Next, a determination is made whether the content filter unit has been enabled (block 910). If not, the V-chip is used as an alternative source for regulating the content to be viewed (arrow 915). If the content filter unit has been enabled, a first evaluation is whether the program being transmitted can be altered and maintained within the parental control limits set for the content filter unit (block 920). This can be accomplished by analysis of a meta-data regarding the content that summarizes the ratings (age or content based), content labels or content tags on a per scene or per program basis. As a result, replacement content having a lower rating (referred to as “down-rating”) or having a higher rating may be substituted for the main (chosen) content, provided such content still falls within the parental control limits (also referred to as “up-rating”).

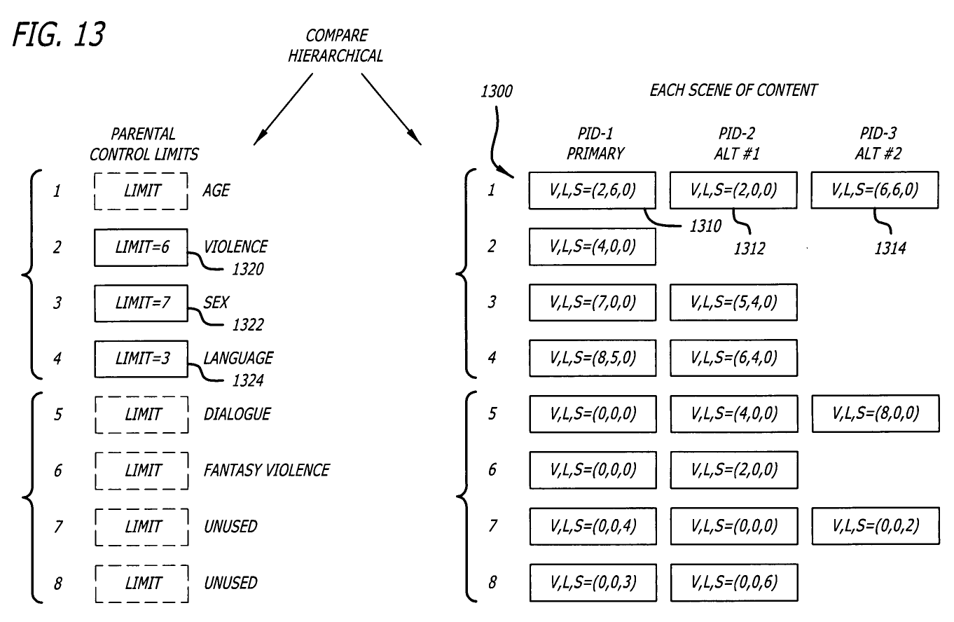

For each scene, a portion of the incoming content segment, such as the Adaptation field for example, is accessed to retrieve information therefrom (block 930). A determination is made whether the received content segment includes control information to enable filtering of the content (block 940). If not, the received content segment is rendered without filtering (block 950). If the received content segment includes control information, a determination is made whether the main content should be substituted for replacement content (blocks 960 and 970). The replacement scheme is set forth in FIG. 11.

FIG. 11 provides an illustrative flowchart of a process for substituting replacement segments of content based on parental control parameters. Initially, as shown in block 1000, parental control parameters associated with the scene are examined. Next, a determination is made whether the display of the scene is controlled based on an Age Rating (block 1010). If so, Age-based rating processing is conducted where the Age Rating of the scene is compared to Aged-based parental control limits programmed by the end user and monitored by the content filter unit (block 1015). In the event that the Age Rating of the scene exceeds the Aged-based parental control limits, the scene is not rendered, but instead may be down-rated through replacement content or blocked.

As an option, the content filter unit can be programmed to substitute replacement content having a higher rating than the main content. The higher rated content would be displayed if the following conditions are met: (1) replacement content has a higher rating than the main content, and (3) the Age Rating of the replacement content does not exceed the Aged-based parental control limits.

For instance, as shown in FIG. 12, an exemplary ratings table 1200 for objectionable content is shown. Herein, the content filter unit is programmed by setting an Age-based parental control limit within a first parental control parameter 1210. As an example, the Age Rating is established to cover age-based rating levels G, PG, PG-13, R and NC-17 ratings used in movies as well as rating levels TV-Y, TV-Y7, TV-Y7-FV, TV-G, TV-14 and TV-MA used in television broadcasts. For instance, TV-14 may have the same Age rating level as PG-13 (V,S), where “V” denotes violence and “S” denotes sexual content.

As an illustrative example, a first scene 1220 of a program may feature PG-13 content as identified by PID-1 (primary), and thus, no substitution is conducted if the Aged-based parental control limit is set to “PG-13”. However, if the Aged-based parental control limit is set to allow only “G” (or lesser rated) movies or related television broadcasting (e.g. TV-G), replacement content associated with PID-2 would be rendered for the first scene. However, if no age threshold was set, the “R” version of the scene would be rendered by substitution of the “PG-13” content associated with PID-1 with “R” scene content associated with PID-3. The same operations would occur for each scene.

As a result, for “PG-13” Aged-based parental control limits set within first parental control parameter 1210, content segments for scenes 1-8 associated with PID-1 would be rendered. For “G” Aged-based limits set within first parental control parameter 1210, content segments associated with PID-1 (scenes 4 and 8) and PID-2 (scenes 1-3 & 5-7) would be shown. Where no Aged-based limits are established and the content filter unit is programmed to increase the rating of the content where possible, content associated with PID-1 (scene 3), PID-2 (scene 8) and PID-3 (scenes 1-2& 4-7) would be shown.

Referring back to FIG. 11, another determination is whether the display of the scene is controlled based on content label scheme (blocks 1020 and 1025). With respect to content label evaluation scheme, a determination is made if any particular category of content is present. This is similar to Content Rating scheme describe below where the “Intensity” parental control limits are set to “0”, which also indicates that if there is any content with this subject matter, replacement content without such subject matter (and within the limits set for other types of subject matter) is selected. If no replacement content is available, the content is blocked or muted.

Yet another determination is whether the display of the scene is controlled based on content rating scheme (block 1030). If so, an Intensity rating is applied to a variety of subject matter categories that parents may find objectionable for their children (block 1035). For instance, these categories may be broadly defined such as violence, sex, language, and the like. For those content segments that include this subject matter, “Intensity” values are assigned for each scene based on the maturity level of the subject matter.

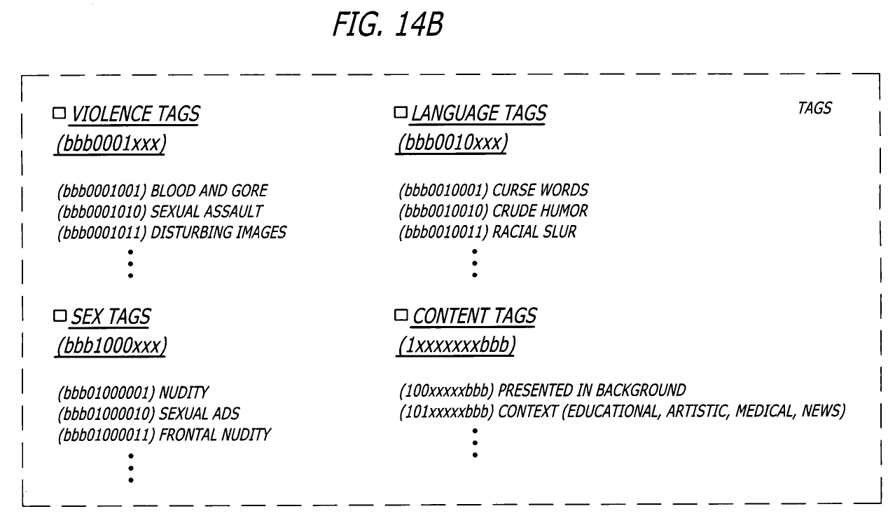

As an illustrative example, as shown in FIG. 13, if a first scene 1300 for main content 1310 of a program includes a fist fight along with a curse word, the violence rating may be set to a first prescribed value, which will likely be fairly low (e.g., 2 out of 15). Depending on the curse word spoken and the audible nature of the curse word, the language rating may be set to a second prescribed value (e.g., 6 out of 15). Replacement content 1312 is provided and associated with PID-2, it may include the elimination of the fist flight and merely a shouting match without any curse words. This replacement content may be substituted if the violence parental control parameters for violence and language are less than “2” and “6”, respectively. Otherwise, the original content is shown since these Intensity values are less than or equal to the parental control limits of “6”, “7” and “3” for violence, language and sex parental control parameters 1320, 1322 and 1324.

Of course, as an alternate, there may be replacement content 1314 where the fist fight is substituted with a knife fight as originally intended by the director for this program. This replacement content would have a higher violence rating (e.g., 6 out of 15). Since the parental control limits for violence were set at “6”, replacement content associated with PID-3 would be shown if up-rating of the content is desired.

For these parent control limits, if no up-rating is desired, scenes 1, 5-6 and 8 would render content associated with PID-1 (primary PID) and scenes 2-4 and 7 would render content associated with PID-2. With respect to scenes 5 and 7, since no up-rating is desired, the main content is normally retained as a default, providing scenes 5 and 7 fall within the parental control limits selected. However, it is contemplated that the default setting can be configured to select the content segment having a rating closest to the parental control limits.

In the event that up-rating of content has been selected, scenes 2 and 8 would render content associated with PID-1 (primary PID), scenes 3-6 would render content associated with PID-2 (first secondary PID) and scenes 1 and 7 would render content associated with PID-3 (second secondary PID).

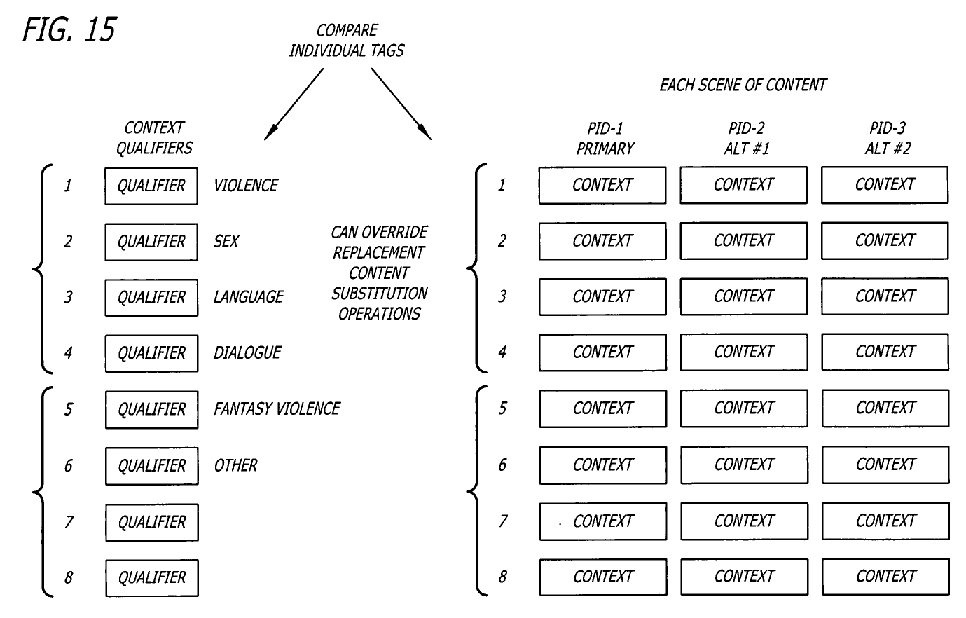

Referring back to FIG. 11, another determination is whether the display of the scene is controlled based on a tag rating scheme (blocks 1040 and 1045). As shown in FIGS. 14A and 14B, the “tag rating” scheme provides a substantial granularity as to what specific content may be excluded. According to one embodiment, each category 1400-1440 and sub-category is uniquely assigned a unique bit pattern so that a 4-byte tag value associated with each scene may be used to identify multiple categories where potential objectionable content may be found. Hence, specific renderings of violence, language, sex, etc. may be prevented.

As an optional configuration, each category may be assigned a particular bit and sub-categories are identified by bit combinations inclusive of the bit assigned to the category. As an example, as shown in FIG. 14B, a tag table may be created where a fourth least significant bit (bbb00001 xxx) of a double word tag (4-bytes, where “b” denotes byte) is set when the scene involves violence. For the violence categories, a number of subcategories may be used to denote blood and gore (bbb00001001); sexual assault (bbb00001010), disturbing images (bbb00001011), etc.

Hence, for each scene, the tag is extracted and processed, such as conducting Exclusive OR'ed with the parent control parameter tags set by the user, in order to determine if any objectionable content is found in the scene. If not, the original content may be displayed. Otherwise, if objectionable content is found, a determination is made whether the replacement content features the objectionable content. If not, the replacement content is displayed. Otherwise, if down-rating is needed, no override is indicated, and no replacement content is available, the main content is blocked or muted.

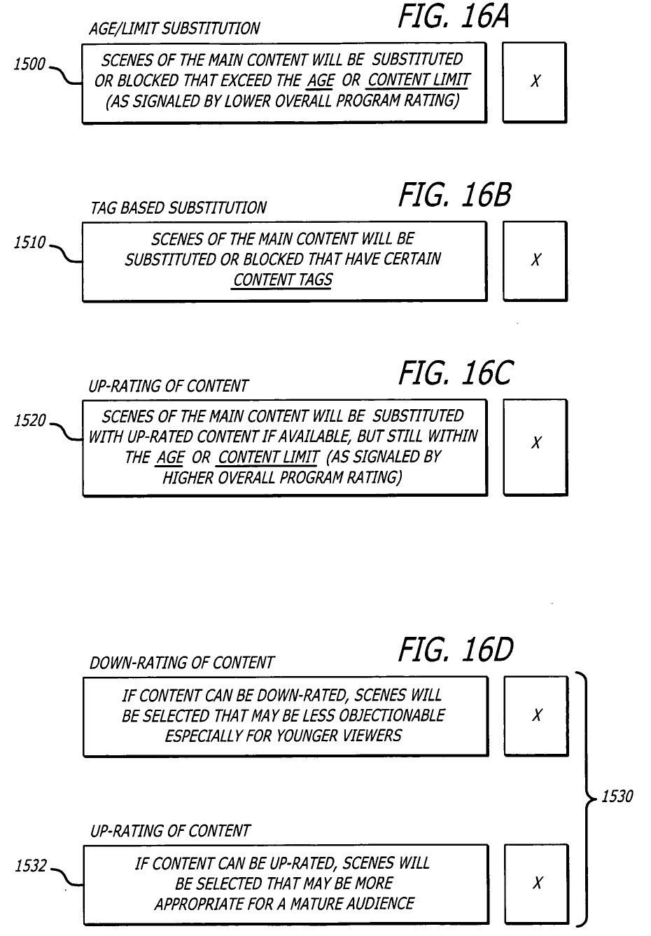

Referring now to FIGS. 14B and 15, an illustrative flow of information and operations for an override scheme, such as using filter blocking summary sub-field 460 of the Adaptation field for example, to override scene replacement based on tag evaluations is shown. Upon determining that the scene includes objectionable content, as an optional feature, a determination may be conducted to understand the context that the objectionable content is featured.

For instance, as an illustrative example, certain nudity may be prevalent for a medical procedure featured in the program. Therefore, if the program is a documentary on medical procedures, various bits reserved in the parental control parameters or separate context identifiers coupled be selected as illustrated in FIG. 14B. Hence, certain sub-categories of sex tags may be ignored. Similarly, a gun fight may be prevalent in a documentary regarding the Wild West so any violence tags below a predetermined rating (e.g., rating “6”) would be ignored. Hence, the context parameter can be used to override the content segment replacement operations described above.

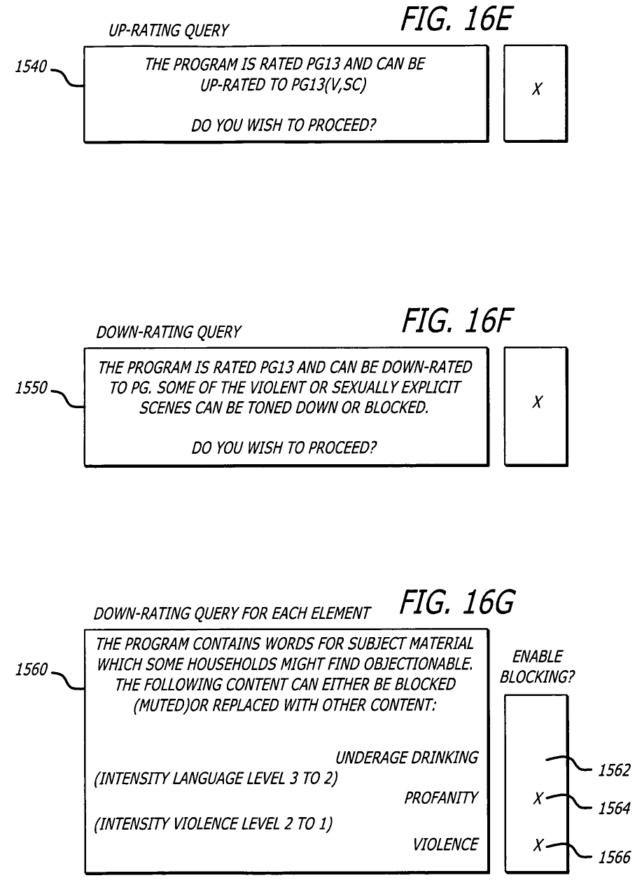

Referring now to FIGS. 16A-16G, exemplary diagrams of graphic user interface (GUI) that enables users to program the content filter unit is shown. FIGS. 16A-16C illustrate programming of the parental control parameters prior to receipt of incoming Transport stream.

FIG. 16A illustrates an exemplary GUI 1500 that allows the user to select, through use of a control panel associated with the digital device or a remote control, whether content segments associated with the original programming should be substituted or blocked when the Age or Content rating exceeds the corresponding parental control limits.

As an illustrative example, a movie has a multi-rating of PG-13 (V,S), PG-13 and PG. The main content has a rating of PG-13, where certain scenes warranted a PG-13 rating, and these scenes having replacement content (e.g., PG and/or PG-13 (V,S)). In the event that parental control limits for the digital device are set to render content having a “PG” rating or less (suitable for 10 year olds), the digital device parses the Adaptation field of the upcoming content for scenes with PG-13 rating. Upon detection, the PG rated version of replacement content is rendered for display.

FIG. 16B illustrates an exemplary GUI 1510 that allows the user to select, through use of a control panel or a remote control, whether content segments associated with the original programming should be substituted or blocked based on content tags identifying content in the scene that is not permitted in accordance with the programmed parental control parameters. As an example, a movie has scenes which show underage drinking. This type of behavior is blocked based on the programmed parental control parameters. Hence, if replacement content is provided where the actors are drinking non-alcoholic beverages, the replacement content is rendered and displayed. Otherwise, the scene is blocked.

FIG. 16C illustrates an exemplary GUI 1520 that allows the user to select, through use of a control panel associated with the digital device or a remote control, whether content segments associated with the original programming should be substituted or blocked up-rated if such content is available and still within the programmed Age or Content limits. As an example, a movie has a multi-rating of PG-13 (V,S), PG-13 and PG. The main content has an Age rating of PG-13, where certain scenes warranted the PG-13 rating. In the event that parental control limits for the digital device are set to render content not exceeding a PG-13 (V,S) rating (suitable for 14 year olds), the digital device parses the Adaptation field of each scene to determine if there is replacement content having PG-13 (V,S) rating. Upon detection, the PG-13 (V,S) rated version of replacement content is rendered.

FIG. 16D illustrates an exemplary GUI 1530 that allows the user to select, through use of a control panel or a remote control, whether content segments associated with the original programming should be always down-rated or up-rated where possible. The up-rating feature 1532 allows a customer to eliminate parental control limits on the digital device, and in fact, provide the content producers with unlicensed freedom to create any program desired, and target a larger viewing audience when alternative scenes of different ratings are provided in certain scenes.

FIG. 16E illustrates an exemplary GUI 1540 that allows the user to select in real-time prior to viewing, through use of a control panel or a remote control, whether content segments associated with the original programming should be up-rated. As an example, a query is generated whether the customer desires a program rated PG-13 and to be up-rated to PG-13 (V,S). Upon selection, the movie is up-rated and if not selected, the movie is rendered according to its original rating.

Similarly, FIG. 16F illustrates an exemplary GUI 1550 that allows the user to select in real-time prior to viewing, through use of a control panel or a remote control, whether content segments associated with the original programming should be down-rated. As an example, a query is generated whether the customer desires a program rated PG-13 (V,S) and to be down-rated to PG-13 through replacement content or blocking techniques (e.g., pixel alteration, etc.). Upon selection, the movie is down-rated and if not selected, the movie is rendered according to its original rating.

Similarly, FIG. 16G illustrates an exemplary GUI 1560 that allows the user to select in real-time prior to viewing, through use of a control panel or a remote control, whether content segments associated with the original programming should be down-rated for particular categories of content. As an example, a query is generated whether the customer desires a program rated PG-13 (V,S) contains words or subject material that some households might find objectionable. The objectionable content is listed (e.g., underage drinking 1562; profanity 1564, violence 1566), and can be selected to block or replace corresponding scene(s) with content that does not have the selected objectionable content. This provides higher granularity for down-rating a program.

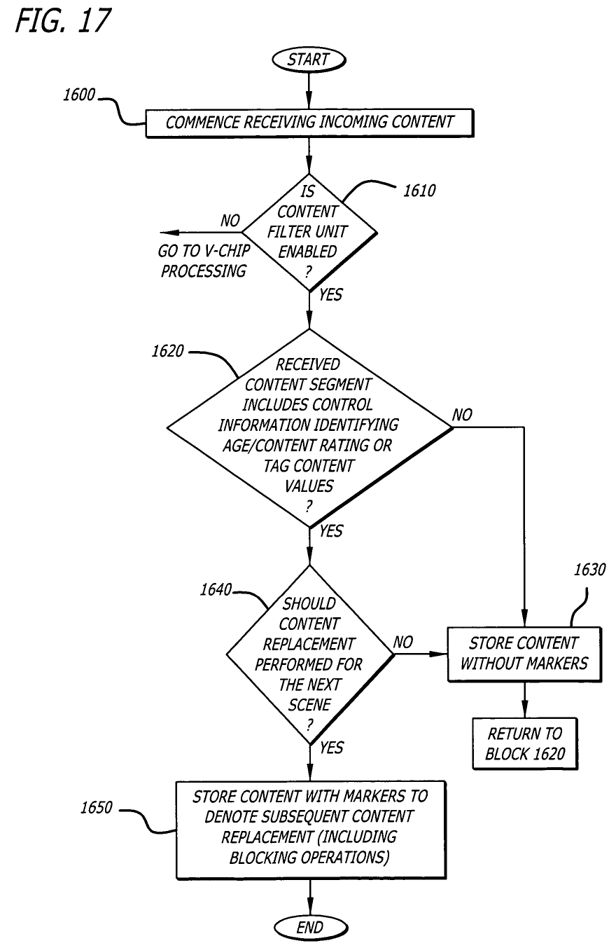

Referring now to FIG. 17, an exemplary diagram of a post-recording content replacement process consistent with certain embodiments of the invention is described. As shown, upon receipt of content into a digital device (e.g., PVR) and determination that the content filtering functionality of the PVR has been enabled, for each scene, a portion of the incoming content segment is accessed to retrieve information concerning the scene (blocks 1600 and 1610). As an illustrative example, private data within an Adaptation field of a MPEG packet may be accessed.

A determination is made whether the evaluated content segment includes control information to enable filtering of the content (block 1620). If not, the received content segment is rendered without filtering (block 1630). In the event that the received content segment includes control information for filtering, a determination is made whether the main content should be substituted for replacement content or blocked (blocks 1640 and 1650). This determination may be accomplished by either determining whether the Age or Content ratings for the scene exceed parental control limits or confirming that content identified in the tag values are not precluded.

If substitution for replacement content or blocking is required, one or more markers are placed within the data stream during storage of the content. These marker(s) are used to identify, during subsequent rendering of the content after storage, which scenes are to be replaced by content from another source (e.g., Internet, accompanying replacement content segments, etc.) or blocked (block 1660).

In the foregoing description, the invention is described with reference to specific exemplary embodiments thereof. It will, however, be evident that various modifications and changes may be made thereto without departing from the broader spirit and scope of the present invention as set forth in the appended claims. The specification and drawings are accordingly to be regarded in an illustrative rather than in a restrictive sense.

What is claimed is:

1. A method comprising:
receiving incoming content including (i) main content being content originally intended as a scene of a program and (ii) replacement content being content for replacing the main content for the scene of the program;
determining if the scene of the program includes objectionable content; and
substituting the main content with the replacement content if the scene of the program includes objectionable content and the replacement content does not include the objectionable content.

2. The method of claim 1, wherein the main content is fifteen frames of video for display.

3. The method of claim 1, wherein the main content includes audio associated with the scene of the program.

4. The method of claim 1, wherein the main content includes at least one frame of video for display.

5. The method of claim 1, wherein the determining if the scene of the program features objectionable content includes accessing information provided with the main content and comparing the information with prior established parental control limits.

6. The method of claim 5, wherein the comparing of the information includes determining whether an Age-based rating assigned to the scene of the program associated with the main content exceeds an Age-based parental control limit being the prior established parental control limit and to substitute the main content with the replacement content if (i) the Age-based rating of the scene associated with the main content exceeds the Age-based parental control limit and (ii) an Age-based rating of the replacement content is less than or equal to the Age-based parental control limit.

7. The method of claim 5, wherein the comparing of the information includes analyzing tag information provided with the main content for the scene, determining by analysis of the tag information if the main content includes content identified as objectionable, and substituting the main content with the replacement content if the main content includes objectionable content as identified by the tag information and the replacement content does not include the objectionable content.

8. The method of claim 7, wherein the comparing of the information further includes preventing substitution of the main content with the replacement content if an override condition exists.

9. The method of claim 1, wherein prior to substituting the main content with the replacement content, the method comprises storing markers identifying a location of objectionable content within the main content, the markers to denote portions of the main content to be substituted with the replacement content during playback from a storage device adapted to store the incoming content.

10. The method of claim 1, wherein the main content is a packet identified by a first program identifier and the replacement content is a packet identified by a second program identifier.

11. The method of claim 1, wherein the replacement content is one of an ad banner and distorted display images.

12. The method of claim 3, wherein the replacement content muted audio.

13. A digital device comprising:
a tuner/demodulation unit adapted to receive incoming content including (i) main content being content originally intended as a scene of a program and (ii) replacement content being content that may be used to replace the main content for the scene of the program; and
a data processing unit coupled to the tuner/demodulation unit, the data processing unit to (i) determine if the scene of the program includes objectionable content that exceeds a preset rating, and (ii) substitute the main content with the replacement content if the scene of the program includes objectionable content that exceeds the preset rating and the replacement content does not include the objectionable content that exceeds the preset rating.

14. The digital device of claim 13, wherein the main content ranges between one and thirty frames of video for display and the preset rating is a parental control limit preset to indicate what subject matter for the content is acceptable for a viewing audience.

15. The digital device of claim 13, wherein the data processing unit includes a processor and a decoder coupled to the processor, the decoder to determine if the scene of the program includes objectionable content and to substitute the main content with the replacement content.

16. The digital device of claim 13, wherein the data processing unit determines if the scene of the program includes objectionable content by accessing meta data provided with the main content and comparing the meta data with the preset rating.

17. The digital device of claim 16, wherein the data processing unit comparing the meta data with the preset rating by determining whether an Age-based rating assigned to the scene of the program associated with the main content exceeds an Age-based parental control limit being the preset rating and to substitute the main content with the replacement content if (i) the Age-based rating of the scene associated with the main content exceeds the Age-based parental control limit and (ii) an Age-based rating of the replacement content is less than or equal to the Age-based parental control limit.

18. The digital device of claim 16, wherein the data processing unit comparing the meta data with the preset rating by analyzing tag information provided with the main content for the scene, determining by analysis of the tag information if the scene of the program as provided by the main content includes objectionable content, and substituting the main content with the replacement content if the tag information associated with the main content indicates that the main content includes objectionable content and tag information associated with the replacement content indicates that the replacement content does not include the objectionable content.

19. The digital device of claim 16, wherein the data processing unit is adapted to prevent substitution of the main content with the replacement content if an override condition exists.

20. The digital device of claim 13, wherein the data processing unit is adapted to store markers within the main content that identify a location of the objectionable content within the main content, the markers to denote portions of the main content to be substituted with the replacement content during playback from a storage device adapted to store the incoming content and in communication with the data processing unit.

21. A machine readable medium to store software that, if executed by logic, will cause a digital device to perform the following operations:
determining if a scene of a program includes objectionable content, the scene of the program being a portion of a first stream of content received by the digital device from an external source; and
substituting the portion of the first stream of content with replacement content if the scene of the program includes objectionable content being content that exceeds a preset parental control limit and the replacement content does not include the objectionable content.

22. A method comprising:
receiving incoming content including main content being content originally intended as a scene of a program and replacement content being content for replacing the main content for the scene of the program;
determining if the replacement content includes content having a higher rating than the main content; and
substituting the replacement content for the main content if (i) the replacement content includes content having a higher rating than the main content, (ii) up-rating is desired, and (iii) the scene of the replacement content is assigned a rating no greater than preset parental control limits.
